(19) United States
(12) Patent Application Publication
(10) Pub. No.: US 2026/0160854 A1
(43) Pub. Date: Jun. 11, 2026

(54) METHOD FOR SUPPRESSING INTERFERENCE SIGNALS IN A RAPID CHIRP FMCW RADAR SENSOR FOR MOTOR VEHICLES

(71) Applicant: Robert Bosch GmbH, Stuttgart (DE)

(72) Inventors: Dirk Bechler, Karlsruhe (DE); Matthias Steinhauer, Steinheim (DE); Michael Schoor, Stuttgart (DE); Rolf Noethlings, Stuttgart (DE)

(21) Appl. No.: 19/129,100

(22) PCT Filed: Jan. 16, 2024
(86) PCT No.: PCT/EP2024/050849

§ 371 Date: May 12, 2025

(30) Foreign Application Priority Data
Feb. 15, 2023 (DE) 10 2023 201 273.1

(51) Int. Cl. G01S 7/02; G01S 7/35; G01S 13/536; G01S 13/58; G01S 13/72

(52) U.S. Cl. CPC G01S 7/023; G01S 7/354; G01S 7/356; G01S 13/536; G01S 13/584; G01S 13/726

(57) ABSTRACT

A method for suppressing interference signals having a known interference signal frequency spectrum in a rapid chirp FMCW radar sensor for motor vehicles. In the method, a baseband signal formed by mixing a transmitted signal with a received signal is subjected to an at least two-dimensional discrete Fourier transformation, wherein one of the at least two dimensions represents a Doppler spectrum, i.e. a spectrum of Doppler frequencies caused by radial velocities of radar targets relative to the radar sensor, and in which the start times of chirps in the transmitted signal are selected such that their spacing from one another differs by non-linearly varying time intervals. The variation width of the time intervals is selected as a function of the interference signal frequency spectrum such that at least one interference signal frequency in the Doppler spectrum is specifically suppressed.

### FIELD

The present invention relates to a method for suppressing interference signals having a known interference signal frequency spectrum in a rapid chirp FMCW radar sensor for motor vehicles, in which a baseband signal formed by mixing a transmitted signal with a received signal is subjected to an at least two-dimensional discrete Fourier transformation, wherein one of the at least two dimensions represents a Doppler spectrum, i.e., a spectrum of Doppler frequencies caused by radial velocities of radar targets relative to the radar sensor, and in which the start times of chirps in the transmitted signal are selected such that their spacing from one another differs by non-linearly varying time intervals Δtₙ.

### BACKGROUND INFORMATION

In a FMCW (Frequency Modulated Continuous Wave) radar, the frequency of the transmitted radar signal is modulated in a ramp-like manner. If the received radar echo is then mixed with a part of the signal transmitted at the same time, the frequency difference between the two signals results in a beat, which produces a baseband signal with a frequency that corresponds to the frequency difference between the transmitted and the received signal. Since this frequency difference is proportional to the signal propagation time and thus proportional to the distance of the located radar target, the frequency of the baseband signal contains information about the distance of the object. In the case of moving radar targets, however, due to the Doppler effect, the frequency of the baseband signal also depends on the relative speed between the radar target and the radar sensor.

In a rapid chirp FMCW radar sensor, very steep frequency ramps, so-called chirps, are transmitted in rapid succession. The steep ramp slope increases the distance sensitivity of the sensor. The ramp slope has no effect on the frequency shift caused by the Doppler effect, however, so that the Doppler effect with respect to the distance-dependent frequency shift can be neglected if the ramp slope is sufficiently steep. Each located object then appears in the Fourier spectrum as a peak at a specific frequency, which provides a good approximation of the distance of the object. Information about the relative speed is obtained by making use of the fact that the radar echoes received from different frequency ramps exhibit a phase shift that depends on the relative speed is used. A second Fourier transformation, in which it is not the signal obtained on a single ramp that is transformed, but rather the signals received for corresponding supporting points in the successive frequency ramps, produces a two-dimensional Fourier spectrum, in which the first dimension indicates the distance of the object and the second dimension indicates the Doppler frequency and thus the relative speed.

Germany Patent No. DE 10 2009 016 480 B4 describes a radar sensor that operates according to this principle, in which the time intervals between the successive chirps are varied in accordance with a random sequence. In conjunction with a special method for object tracking, this variation of the time intervals is intended to improve the checking of the plausibility of objects and the resolution of ambiguities in the determination of relative speeds. A side effect to also be mentioned, however, is that the variation of the time intervals can lead to a greater robustness of the radar location with respect to interference signals.

### SUMMARY

An object of the present invention is to improve the suppression of interference signals in scenarios in which interference signals having a known frequency or frequency distribution are scattered into the radar sensor.

This object may be achieved according to the present invention by selecting the variation width Δ of the time intervals Δt, in a radar sensor of the aforementioned type as a function of the interference signal frequency spectrum in such a way that at least one interference signal frequency fᵢ in the Doppler spectrum is specifically suppressed.

The present invention makes use of the fact that varying the intervals between the chirps leads to phase shifts in the baseband signal, which are then converted into frequency shifts in the Doppler spectrum during the Fourier transformation. In principle, however, this effect in the Doppler spectrum not only broadens and flattens the peaks caused by interference signals, but also the peaks caused by the useful signal that indicate the relative speed of real radar targets. For a signal with a given frequency, the flattening of the signal peaks depends not only on the variation width of the chirp spacing, but also on the frequency of the respective signal. Knowing the frequency of an interference signal then makes it possible to set the variation width such that the signal peaks caused by the interference signal are specifically suppressed, while the spectrum for useful signals, which typically have a different frequency, is hardly affected, and thus improve the detectability of real radar targets.

The present invention can, for instance, be used to suppress interference signals caused by a clocked voltage regulator that is, for example, used to supply power to the radar sensor and/or other electronic components in the vehicle. The switching frequency of the voltage regulator leads to a ripple in the supply voltage for the radar electronics. In the sensitive circuit components of the radar sensor's transmit and receive circuits, this can lead to the coupling of an interference frequency into the transmit or receive signal and ultimately impair the evaluability of the receive signal. A conventional method for reducing such interference is using passive filters (L-C filters) to attenuate the amplitude of the ripple to such an extent that interference can no longer be detected in the spectrum of the receive signal. Due to the high sensitivity of the transmit and receive circuit components, however, the requirements for the filter effect are very high which makes this type of interference suppression is very laborious.

Another conventional approach to reducing the maximum interference power at the switching frequency and its higher harmonics is varying the switching frequency over time (spread spectrum method) to spectrally distribute the power. In general, however, due to the boundary conditions that have to be observed, the options for varying the switching frequency of the voltage regulator are very limited, so this approach does not always lead to success. The method according to the present invention, on the other hand, has the advantage that there is no need to spread the interference frequency; instead, only the associated peak in the Doppler spectrum is spread.

However, the method according to the present invention can also be used to suppress other interference signals that typically arise in the vicinity of the radar sensor in a motor vehicle, the frequencies of which are known.

Advantageous example embodiments and further developments of the present invention are disclosed herein.

In some conventional rapid chirp radar sensors, the chirps are grouped into packets that are separated from one another by specific time gaps. It is then possible to vary the start times of the individual packets, while the intervals between the chirps within a packet can be uniform. The variation width of the time intervals is then limited only by the minimum size of the time gaps and can thus be significantly greater than the time interval between two consecutive chirps within a packet. Of course, the intervals between the chirps can also be varied within a package, albeit with a smaller variation width. The two different variation widths can then be used to suppress two different interference signals, for instance.

The present invention also relates to a radar sensor in which the above-described method of the present invention is implemented and in which the variation width of the time intervals is matched to the frequency of an internal interference signal source of the radar sensor.

The present invention further relates to a motor vehicle comprising a radar sensor in which the above-described method of the present invention is implemented and in which the variation width of the time intervals is matched to the frequency of an interference signal source inside the motor vehicle.

Embodiment examples of the present invention are explained in more detail in the following with reference to the figures.

### BRIEF DESCRIPTION OF THE DRAWINGS

FIG. 1 shows a block diagram of an FMCW radar sensor in which the present invention can be used.

FIG. 2 shows a set of charts to illustrate the operation of a rapid chirp FMCW radar sensor, according to an example embodiment of the present invention.

FIG. 3 shows an example of a modulation scheme for a radar sensor according to FIG. 2.

FIG. 4 shows a further example of a modulation scheme for a rapid Chirp FMCW radar according to another example embodiment of the present invention.

FIG. 5 shows a simplified illustration of details of a modulation scheme based on the principle illustrated in FIG. 4.

FIG. 6 shows another variant of the modulation scheme according to FIG. 4.

FIG. 7 shows a sketch of a motor vehicle comprising a radar sensor and an interference signal source.

### DETAILED DESCRIPTION OF EXAMPLE EMBODIMENTS

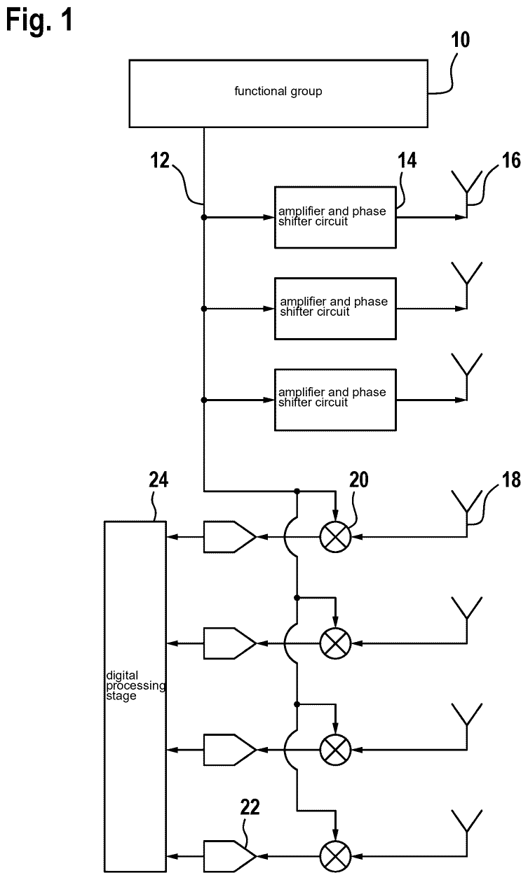

A typical design of a radar sensor to which the present invention can be applied will be explained with reference to a block diagram shown in FIG. 1. The radar sensor comprises a functional group 10 for generating a transmission signal 12 in the radar frequency range (76-81 GHZ). This signal is fed to transmit antennas 16 via parallel amplifier and phase shifter circuits 14.

Reception signals, e.g. the radar echoes received from different radar targets, are received via a plurality of parallel receive antennas 18 and mixed with the transmission signal 12 via mixers and thus converted into so-called baseband signals with lower frequencies. In the baseband range, the signals are amplified, filtered, and digitized by suitable circuits 22.

Further processing of the baseband signals to detect the radar targets and calculate measured variables such as distances, relative speeds and location angles of the radar targets takes place in a digital processing stage 24.

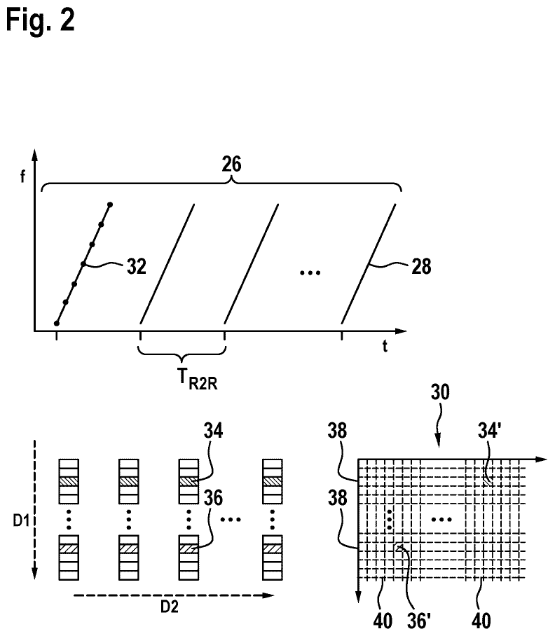

The properties of the radar sensor with respect to the measurement of the distance and speed of objects are determined substantially from the signal shape or signal modulation of the transmission signals. Current radar sensors are mostly based on variations of the so-called rapid chirp or chirp sequence modulation which is illustrated in FIG. 2. The frequency f of the transmission signals 12 is shown there as a function of the time t. A modulation sequence 26 for acquiring the surroundings consists of a series of uniform FMCW ramps or chirps 28 that are emitted at equidistant time intervals T_{R2R}.

Using a two-dimensional Fourier transformation (Fast Fourier transformation FFT), the digital reception signals in the baseband are transformed into a spectrum 30 for each transmit and receive channel. In a first dimension D1, Fourier transformations are carried out for the individual chirps 28.

The input variables are the complex amplitudes of the baseband signal at times that correspond to a sequence of supporting points 32 on the chirp 28. Each power peak 34, 36 in the one-dimensional spectrum in this dimension D1 corresponds to a radar target to which radar sensor has a specific distance that is proportional to the frequency of the peak. In a second dimension D2, Fourier transformations are carried out over corresponding supporting points 32 in the successive chirps 28. A reflected signal thus leads to a power peak 34′, 36′ in the two-dimensional spectrum 30, the frequency position of which in the dimension D2 indicates the relative speed of the respective radar target. The spectrum 30 is accordingly divided into distance bins 38 in the first dimension D1 and into speed bins in the second dimension D2. Within each distance bin 38, the distribution of the signal power across the speed bins 40 represents a Doppler spectrum. If the reflection signal has sufficient power, the power peaks 34′, 36′ assigned to the different radar targets can be detected and assigned to a respective pair of distance bin and speed bin. The modulation parameters of the chirp sequence modulation assign a specific range of object distances to each distance bin 38 and a specific range of relative speeds to each speed bin 40. The coordinates (distance and speed) of a located radar target can thus be ascertained using the indices of the distance and speed bins.

The location angles of the radar targets are determined in a conventional manner using the phase relationships between the signals received in the different receiving channels.

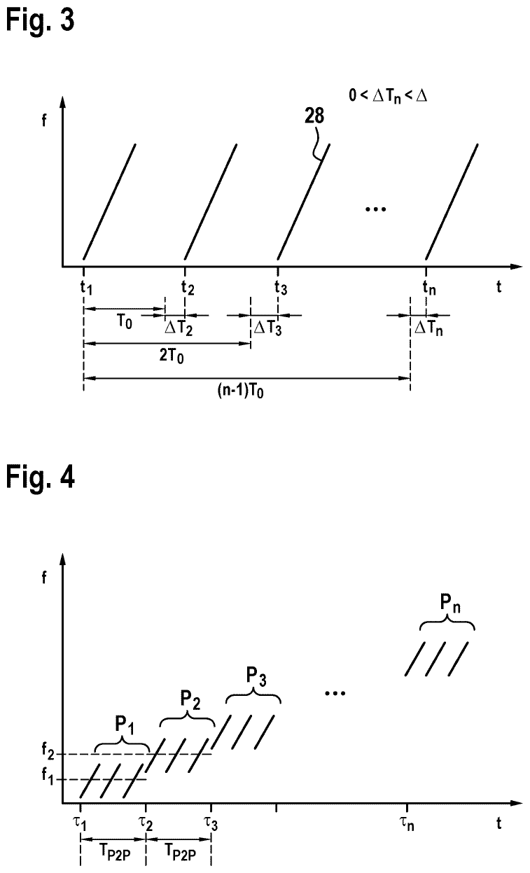

According to the present invention, the above-described method, in particular the modulation scheme used, is modified in such a way that signals from known interference sources in the spectrum can be more specifically suppressed. Instead of a time equidistant transmission of the chirps, the start times of the individual chirps 28 are each offset by a non-linearly varying time interval ΔTₙ. This results in a “jittering” of the sampling times for the Doppler processing of the radar sensor's received signals. As shown in FIG. 3, the start times tₙ of the chirps 28 (for n>1) are determined according to the following formula (1):

$${t}_{n} = {t}_{1} + ( n - 1 ) {T}_{0} + Δ {T}_{n} \qquad ( 1 )$$

The interval between the start times of two successive chirps 28 is thus composed of a fixed component T₀ and a variable time interval ΔTₙ. The variable time interval ΔTₙ is always greater than 0 and less than a specific variation width Δ. An upper limit for the variation width Δ results from the fact that the successive chirps 28 are not permitted to overlap. Therefore, if Tᵣ is the ramp duration, the following must apply:

$$Δ \leq {T}_{0} - {T}_{r} \qquad ( 2 )$$

The time intervals ΔTₙ should vary irregularly, in particular non-linearly, and can, for instance, be generated using a random number generator. Alternatively, a fixed sequence of time intervals ΔTₙ can be specified, which repeats after a specific (ideally large) number of chirps 28. The time intervals are preferably distributed evenly across the interval [0, Δ].

FIG. 4 shows another variant of a conventional chirp sequence method. A plurality of chirps 28 that follow one another at regular intervals are combined into packets P₁, P₂, . . . , Pₙ, which are separated from one another by specific time gaps. The center frequency f₁, f₂, . . . , fₙ of the chirps 28 differs from packet to packet and is varied linearly over the sequence of packets. In the conventional methods of this type, the start times τ₁, τ₂, . . . , τₙ of the packets P₁, P₂, . . . , Pₙ are separated from one another by constant time intervals Tₚ₂ₚ.

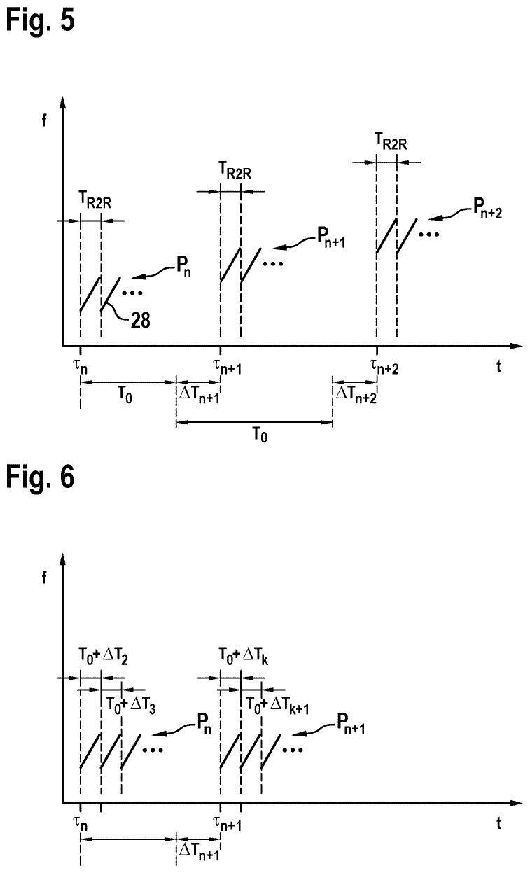

A possible adaptation of the present invention to this version of the chirp sequence method is shown in FIG. 5. Only the initial sequences of three consecutive packets Pₙ, Pₙ₊₁, Pₙ₊₂ are shown here. The interval between the start times τₘ, τₘ₊₁ bzw. τₘ₊₁, τₘ₊₂ of two consecutive packets is composed of a fixed component T₀ and a variable time interval ΔTₙ₊₁ or ΔTₙ₊₂. The intervals T_{R2R} between the start times of consecutive chirps 28 within each packet, on the other hand, are constant. The time intervals Δ_{Tn+1}, . . . can also only vary within a specific variation width Δ, which in this case is limited by the fact that the successive packets are not permitted to overlap. The greater the time gaps between the individual packets Pₙ, . . . , the more latitude there is for varying the of the time intervals ΔTₙ₊₁, . . . .

FIG. 6 shows an embodiment variant in which the start times τₙ, τₙ₊₁ . . . of the packets vary in the same manner as in FIG. 5, but in which the start times of the chirps 28 within each packet are varied as well. Within each packet, the intervals between the start times of the chirps are composed of a fixed component T₀ and a variable component ΔT₂, ΔT₃ or ΔT_{K}, ΔT_{K+1}. The indices k and k+1 symbolize that the sequence in which the time intervals vary can be different for different packets. Alternatively, of course, the same variation scheme can also be used for all packages.

The effect of the variation of the time intervals ΔTₙ can be explained using the following signal model. For the phases φₙ of the reception signals obtained from the nth chirp or the nth packet as a result of a reflection on a single object, the following relationship applies:

$${φ}_{n} = 4 π ( {f}_{n} / c ) \cdot v \cdot {t}_{n} + {φ}_{0} = 4 π ( {f}_{n} / c ) \cdot v \cdot ( n \cdot {T}_{0} + Δ {T}_{n} ) \qquad ( 3 )$$

fₙ is the center frequency of the chirp or the packet, c is the speed of light, v is the relative speed of the object, is the start time of the nth chirp or the nth packet, and φ0 is the phase of the reception signal that would be obtained for an object having a relative speed of v=0. If an interference signal with the frequency fᵢ is superimposed on the reception signal, the following relationship applies:

$$\begin{matrix}{φ}_{n} = 2 π ( ( 2 {f}_{n} / c ) \cdot v + {f}_{i} ) \cdot {t}_{n} + {φ}_{0} \\ = 4 π ( {f}_{n} / c ) \cdot v \cdot ( n \cdot {T}_{0} + Δ {T}_{n} ) + 2 π \cdot {f}_{i} \cdot ( n \cdot {T}_{0} + Δ {T}_{n} ) + {φ}_{0}\end{matrix} \qquad ( 4 )$$

In this expression (2fₙ/c) is the Doppler frequency far which should be determined as accurately as possible in the spectrum in order to measure the relative speed v. Therefore the following applies:

$$\begin{matrix}{φ}_{n} = 2 π {f}_{d} \cdot ( n \cdot {T}_{0} + Δ {T}_{n} ) + 2 π \cdot {f}_{i} \cdot ( n \cdot {T}_{0} + Δ {T}_{n} ) + {φ}_{0} \\ = 2 π {f}_{d} \cdot n \cdot {T}_{0} + 2 π {f}_{d} \cdot Δ {T}_{n} + 2 π {f}_{i} \cdot n \cdot {T}_{0} + 2 π {f}_{i} Δ {T}_{n} + {φ}_{0}\end{matrix} \qquad ( 5 )$$

The variation of the time intervals ΔTₙ leads to a desired phase modulation of the interference signal due to the interference signal term 2π fᵢ ΔTₙ and an undesirable phase modulation of the useful signal due to the useful signal term 27 π f_{d}·ΔTₙ. Due to the Fourier transformation in the second dimension D2, these phase modulations cause a “smearing” of the power peak over a frequency range that can extend over multiple speed bins and a corresponding flattening of the peak. In order to suppress an interference signal with a high interference signal frequency fᵢ, the variation width Δ of the time intervals ΔTₙ can be selected such that it is in the order of Δ=½fᵢ. The interference signal peak is then broadened and flattened as desired so that it is no longer incorrectly interpreted as a reflection from an object. Moreover, because the chirp sequence consists of pairs of chirps the phases of which are offset 180° from one another due to the phase modulation, all odd harmonics of the interference signal frequency are suppressed. For the useful signal peak, on the other hand, the smearing is less by a factor of 1/fᵢ<<1, and side peaks of the useful signal peak are effectively suppressed regardless of the Doppler frequency of the object, so that the real radar target remains easily detectable.

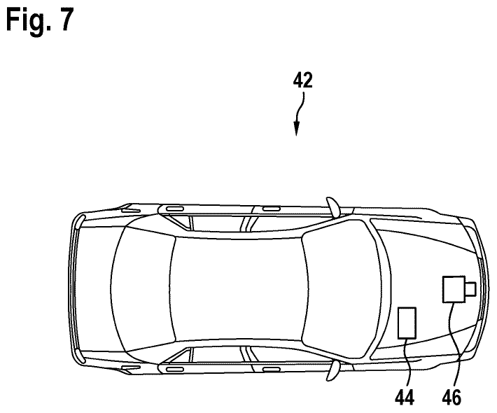

FIG. 7 schematically shows a motor vehicle 42 that contains an interference signal source 44 having a known frequency spectrum. This motor vehicle also comprises a radar sensor 46 that operates in accordance with the above-described principle. The variation width Δ in the radar sensor 46 is tuned to the dominant interference signal frequency fᵢ of the interference signal source 44, so that its interference signals are effectively suppressed when the radar echoes are evaluated.

1-8. (canceled)

9. A method for suppressing interference signals having a known interference signal frequency spectrum in a rapid chirp FMCW radar sensor for a motor vehicle, the method comprising:
subjecting a baseband signal formed by mixing a transmitted signal with a received signal to an at least two-dimensional discrete Fourier transformation, wherein one of the at least two dimensions represents a Doppler spectrum including a spectrum of Doppler frequencies caused by radial velocities of radar targets relative to the radar sensor, start times of chirps in the transmitted signal being selected such that their spacing from one another differs by non-linearly varying time intervals;
wherein a variation width Δ of the time intervals is selected as a function of the interference signal frequency spectrum such that at least one interference signal frequency in the Doppler spectrum is specifically suppressed.

10. The method according to claim 9, wherein the transmitted signal includes a sequence of packets that each include a plurality of chirps and are separated from one another by time gaps, and intervals between start times of the packets differ from one another by non-linearly varying time intervals.

11. The method according to claim 10, wherein the time intervals between the chirps within each packet are equidistant.

12. The method according to claim 10, wherein the chirps belonging to different packets differ from one another in their center frequency.

13. The method according to claim 10, wherein the method is for suppressing interference signals having a dominant interference signal frequency fᵢ, and wherein the variation width Δ of the time intervals is between ¼fᵢ and 1/fᵢ.

14. The method according to claim 9, wherein the time intervals between the respective start times of the chirps are additively composed of a fixed component and the varying time intervals, wherein consecutive time intervals form a random sequence or pseudo-random sequence and are evenly distributed over an interval [0, Δ].

15. A radar sensor, comprising:
an internal interference signal source;
wherein the radar sensor is configured to suppress interference signals having a known interference signal frequency spectrum in a rapid chirp FMCW radar sensor for a motor vehicle, by performing the following:
subjecting a baseband signal formed by mixing a transmitted signal with a received signal to an at least two-dimensional discrete Fourier transformation,
wherein one of the at least two dimensions represents a Doppler spectrum including a spectrum of Doppler frequencies caused by radial velocities of radar targets relative to the radar sensor, start times of chirps in the transmitted signal being selected such that their spacing from one another differs by non-linearly varying time intervals;
wherein a variation width Δ of the time intervals is selected as a function of the interference signal frequency spectrum such that at least one interference signal frequency in the Doppler spectrum is specifically suppressed.

16. A motor vehicle, comprising:
an internal interference signal source; and
a radar sensor configured to suppress interference signal frequencies of the interference signal source, the radar sensor configured to:
subject a baseband signal formed by mixing a transmitted signal with a received signal to an at least two-dimensional discrete Fourier transformation, wherein one of the at least two dimensions represents a Doppler spectrum including a spectrum of Doppler frequencies caused by radial velocities of radar targets relative to the radar sensor, start times of chirps in the transmitted signal being selected such that their spacing from one another differs by non-linearly varying time intervals,
wherein a variation width Δ of the time intervals is selected as a function of the interference signal frequency spectrum such that at least one interference signal frequency in the Doppler spectrum is specifically suppressed.
